(19) United States
(12) Patent Application Publication
(10) Pub. No.: US 2026/0197632 A1
(43) Pub. Date: Jul. 9, 2026

(54) OPTIMIZING ANONYMIZED PARAMETERS DISTRIBUTION IN MULTI-LINK OPERATION

(71) Applicant: Cisco Technology, Inc., San Jose, CA (US)

(72) Inventors: Domenico FICARA, Essertines-Sur-Yverdon (CH); Ugo M. CAMPIGLIO, Morges (CH); Javier I. CONTRERAS ALBESA, Sant Cugat del Valles (ES); Jerome HENRY, Pittsboro, NC (US)

(21) Appl. No.: 19/207,235

(22) Filed: May 13, 2025

Related U.S. Application Data
(60) Provisional application No. 63/743,422, filed on Jan. 9, 2025.

(51) Int. Cl. H04W 12/02; H04W 74/0808; H04W 76/15

(52) U.S. Cl. CPC H04W 12/02; H04W 74/0825; H04W 76/15

(57) ABSTRACT

Techniques and apparatus for improving distribution of anonymized parameters in multi-link operation (MLO) are described. An example technique includes determining a respective set of anonymized parameters for each link of a plurality of links for a plurality of epochs. The plurality of links are established between the AP MLD and a station (STA) MLD. The technique also includes determining, based on the sets of anonymized parameters, that a plurality of anonymized parameter collisions are expected to occur on at least a first link and a second link of the plurality of links during one or more epochs of the plurality of epochs. A frame including an indication of the plurality of anonymized parameter collisions on the first link and the second link is generated. The frame is transmitted to the STA MLD.

### CROSS-REFERENCE TO RELATED APPLICATIONS

This application claims benefit of co-pending U.S. provisional patent application Ser. No. 63/743,422 filed Jan. 9, 2025. The aforementioned related patent application is herein incorporated by reference in its entirety.

### TECHNICAL FIELD

Embodiments presented in this disclosure generally relate to wireless communications. More specifically, embodiments disclosed herein provide techniques for improving distribution of anonymized parameters in multi-link operation (MLO).

### BACKGROUND

In many wireless networks, clients (e.g., wireless devices or non-access point (AP) stations (STAs) (non-AP STAs)) can be susceptible to tracking by unauthorized (e.g., malicious) users. For example, an unauthorized user can gain access to a wireless network with a rogue AP and use the rogue AP to intercept packages and track the movement and activity of clients within the network based on the intercepted packets. To mitigate against such unauthorized tracking, certain wireless networks (e.g., Institute of Electrical and Electronics Engineers (IEEE) 802.11, also known as WiFi) have introduced several privacy enhancements that aim to provide clients with the ability to avoid being tracked within a network. These privacy enhancements generally involve anonymizing frame parameters, such as an association identifier (AID), a medium access control (MAC) address, a packet number (PN), a sequence number (SN), among others.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system, according to certain embodiments.

FIG. 2 illustrates an example architecture of a multi-link device (MLD), according to certain embodiments.

FIG. 3 illustrates an example call flow for distributing anonymized parameters in MLO, according to certain embodiments.

FIG. 4 is a flowchart of a method for indicating anonymized parameter collisions in MLO, according to certain embodiments.

FIG. 5 illustrates an example computing device, according to certain embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment described herein is a computer-implemented method for wireless communication performed by an access point (AP) multi-link device (MLD). The computer-implemented method includes determining a respective set of anonymized parameters for each link of a plurality of links for a plurality of epochs, the plurality of links being established between the AP MLD and a station (STA) MLD. The computer-implemented method also includes determining, based on the sets of anonymized parameters, that a plurality of anonymized parameter collisions are expected to occur on at least a first link and a second link of the plurality of links during one or more epochs of the plurality of epochs. The computer-implemented method also includes generating a frame comprising an indication of the plurality of anonymized parameter collisions on the first link and the second link. The computer-implemented method further includes transmitting the frame to the STA MLD.

Another embodiment described herein is an access point (AP) multi-link device (MLD). The AP MLD includes one or more memories collectively storing instructions, and one or more processors communicatively coupled to the one or more memories. The one or more processors are individually or collectively configured to execute the instructions to cause the AP MLD to perform an operation. The operation includes determining a respective set of anonymized parameters for each link of a plurality of links for a plurality of epochs, the plurality of links being established between the AP MLD and a station (STA) MLD. The operation also includes determining, based on the sets of anonymized parameters, that a plurality of anonymized parameter collisions are expected to occur on at least a first link and a second link of the plurality of links during one or more epochs of the plurality of epochs. The operation also includes generating a frame comprising an indication of the plurality of anonymized parameter collisions on the first link and the second link. The operation further includes transmitting the frame to the STA MLD.

Another embodiment described herein is a non-transitory computer-readable medium. The non-transitory computer-readable medium includes computer-executable code, which when executed by one or more processors of an access point (AP) multi-link device (MLD) perform an operation. The operation includes determining a respective set of anonymized parameters for each link of a plurality of links for a plurality of epochs, the plurality of links being established between the AP MLD and a station (STA) MLD. The operation also includes determining, based on the sets of anonymized parameters, that a plurality of anonymized parameter collisions are expected to occur on at least a first link and a second link of the plurality of links during one or more epochs of the plurality of epochs. The operation also includes generating a frame comprising an indication of the plurality of anonymized parameter collisions on the first link and the second link. The operation further includes transmitting the frame to the STA MLD.

Other embodiments provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein.

### Example Embodiments

Certain wireless systems (e.g., IEEE 802.11bi among other wireless standards) support enhanced data privacy (EDP), which includes several privacy enhancements that aim to provide clients (e.g., station (STA) multi-link devices (MLDs), also referred to as non-AP MLDs) with the ability to avoid being tracked within a network. EDP involves dynamically updating various (unencrypted) wireless frame parameters associated with a client (e.g., AID, MAC address, SN, PN, among other parameters) at defined time intervals, referred to herein as “epochs” or “EDP epochs.” Such periodic changes in wireless frame parameters may be referred to as frame anonymization.

Frame anonymization enables restricting presence monitoring time windows to portions of a single association between a client and AP. As such, frame anonymization may improve the client's privacy by making it difficult for an observer (e.g., attacker, malicious user, unauthorized user) to correlate the (updated) frame parameters with a client's presence across different time intervals.

One potential drawback to frame anonymization in current wireless systems that support EDP operations is that such frame anonymization generally involves establishing a respective frame anonymization parameter set per link established between the client (e.g., STA MLD) and AP (e.g., AP MLD). Each frame anonymization parameter set includes, for example, the set of frame anonymization parameters (e.g., AID, MAC address, SN, PN, among others) to apply to communications between the client and AP on the respective link. However, performing frame anonymization per link can involve a substantial amount of messaging between the client and AP, increasing overhead and significantly impacting the communication performance of the clients in terms of reduced throughput, increased latency, and lower transmission range, as illustrative examples.

Certain embodiments described herein provide techniques for improving the distribution of anonymized parameters in MLO. As described in greater detail herein, certain embodiments provide techniques for significantly reducing the amount of messaging used to establish frame anonymization parameter sets across a set of links (e.g., N links) in MLO. By reducing the amount of messaging used to establish frame anonymization parameter sets, embodiments described herein can significantly improve the communication performance of clients during EDP operation in terms of increased throughput, decreased latency, and higher transmission range, as illustrative examples.

Note, the techniques described herein for improving distribution of anonymized parameters in MLO may be incorporated into (such as implemented within or performed by) a variety of wired or wireless apparatuses (such as nodes). In some implementations, a node includes a wireless node. Such wireless nodes may provide, for example, connectivity to or from a network (such as a wide area network (WAN) such as the Internet or a cellular network) via a wired or wireless communication link. In some implementations, a wireless node may include an AP MLD, a controller, or a STA MLD.

Although the terms “first,” “second,” “third,” etc., may be used herein to describe various elements, components, regions, layers and/or sections, these elements, components, regions, layers and/or sections should not be limited by these terms. These terms may be only used to distinguish one element, component, region, layer or section from another element, component, region, layer, or section. Terms such as “first,” “second,” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”.

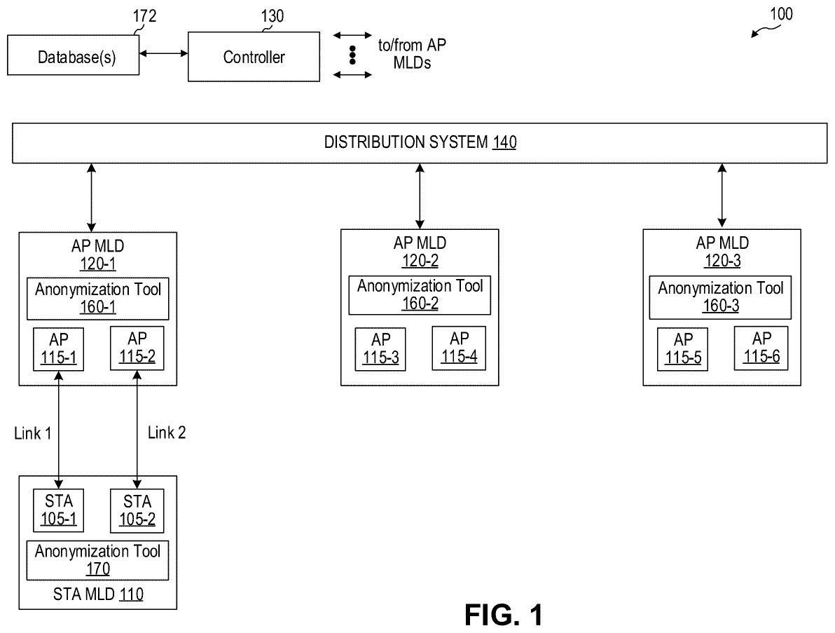

FIG. 1 illustrates an example system 100 in which one or more techniques described herein can be implemented, according to certain embodiments. As shown, the system 100 includes, without limitation, one or more AP MLDs 120 (e.g., AP MLD 120-1, AP MLD 120-2, and AP MLD 120-3), a STA MLD 110, a distribution system (DS) 140, a controller 130, and one or more databases 172. In certain embodiments, the system 100 may implement a wireless network according to one or more wireless communication standards, such as one or more of the IEEE 802.11 standards.

An AP MLD is generally a fixed station that communicates with STA MLD(s) and may be referred to as a base station, an AP, an AP STA, a MLD, a network entity, a wireless device, or some other terminology. A STA MLD may be fixed or mobile and also may be referred to as a mobile STA MLD, a client MLD, a MLD, a client STA MLD, a non-AP MLD, a client, a wireless device, or some other terminology. Note that while a certain number of AP MLDs and STA MLDs are depicted, the system 100 may include any number of AP MLDs and STA MLDs.

As used herein, an AP MLD along with the STA MLDs associated with the AP MLD (e.g., within the coverage area (or cell) of the AP MLD) may be referred to as a basic service set (BSS). The AP MLD 120-1, AP MLD 120-2, and AP MLD 120-3 may be neighboring (peer) AP MLDs. The AP MLDs 120 may communicate with one or more STA MLDs 110 on the downlink and uplink. The downlink (e.g., forward link(s)) is the communication link(s) from the AP MLD 120 to the STA MLD(s) 110, and the uplink (e.g., reverse link(s)) is the communication link(s) from the STA MLD(s) 110 to the AP MLD 120. In some cases, a STA MLD may also communicate peer-to-peer with another STA MLD.

The AP MLDs 120 and the STA MLD 110 are generally representative of any device capable of performing multi-link operations. Here, each AP MLD 120 includes two APs (which may be referred to herein as “radios”). As illustrated, AP MLD 120-1 includes AP 115-1 and AP 115-2, AP MLD 120-2 includes AP 115-3 and AP 115-4, and AP MLD 120-3 includes AP 115-5 and AP 115-6. Similarly, STA MLD 110 includes two STAs 105-1 and 150-2 (which may be referred to herein as “radios”). Although each AP MLD 120 is depicted as including two APs, it should be noted that each AP MLD 120 may include any number of APs. Similarly, while STA MLD 110 is depicted with two STAs, it should be noted that the STA MLD may include any number of STAs.

As used herein, the term “radio” may refer to the capability to connect to a peer device on a link. Thus, by way of example, the two APs 115-1 and 115-2, as depicted within AP MLD 120-1, may represent either two physical radios or two logical radios enabled by a single physical radio (which is capable of being used on two different links in a time-switched fashion). Similarly, the two STAs 105-1 and 150-2, as depicted within STA MLD 110, may represent either two physical radios or two logical radios enabled by a single physical radio (which is capable of being used on two different links in a time-switched fashion).

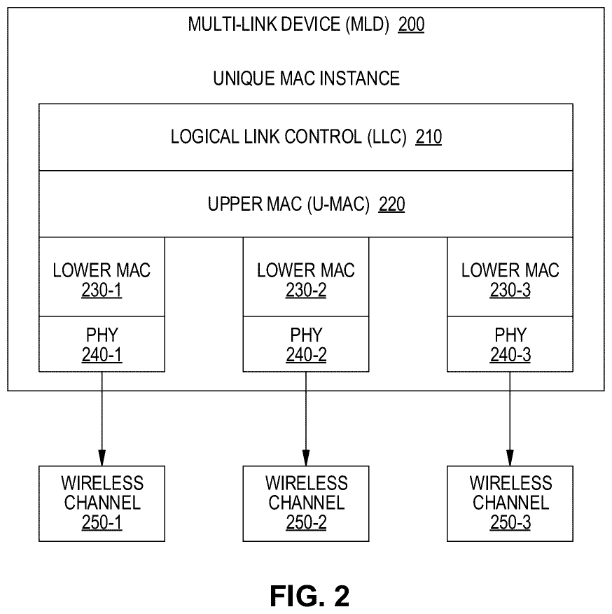

FIG. 2 illustrates an example architecture of a MLD 200, according to certain embodiments. The MLD 200 may be an AP MLD 120 or a STA MLD 110. As depicted in FIG. 2, the MLD 200 provides a unique MAC instance to multiple wireless interfaces (e.g., wireless channels 250 1-N), each of which may be utilized by a respective “radio” (e.g., AP 115 or STA 105). The MLD 200 includes a logical link control (LLC) layer 210 and an upper MAC (U-MAC) layer 220. The upper MAC layer 220 is a common part of the MAC sub-layer for all the interfaces (e.g., wireless channels 250 1-N). The MLD 200 also includes a respective lower MAC (L-MAC) 230 1-N for each interface. Each respective L-MAC 230 manages a corresponding physical (PHY) layer 240 as well as link specific functionalities (e.g., channel access) for the corresponding wireless channel 250 (e.g., link).

A MLD may generally be classified based on whether it is a single radio MLD or multi-radio MLD. Single radio MLDs generally use a single radio to switch between one or more links. One category of single radio MLDs is Enhanced Multi-Link Single Radio (eMLSR). eMLSR devices generally operate one main wireless radio that can transmit and/or receive data frames on a given link, but can detect some data (e.g., short initial frames) on a set of other links when the device is not actively transmitting or receiving. Multi-radio MLDs may generally be classified into the following two types: (i) simultaneous transmission and reception (STR) MLD and (ii) non-STR MLD. For STR MLDs, a transmission on one link may not affect the operations of frame reception and clear channel assessment (CCA) on other links. Stated differently, for STR MLDs, individual links can operate independently of each other. For non-STR MLDs, operation on one link may be restricted by operation on another link. For example, a transmission on one link may not be allowed if it will cause reception interruption on another link. In another example, a reception or CCA on one link may not be allowed if a transmission is ongoing on another link.

Referring back to FIG. 1, in certain embodiments, the AP MLDs 120 may be controlled or managed at least partially by the controller 130. Here, the controller 130 couples to and provides coordination and control for the AP MLDs 120 1-3. For example, the controller 130 may handle adjustments to RF power, channels, authentication, and security for the AP MLDs 120. In certain embodiments, the controller 130 may also coordinate the links formed by the AP MLDs 120. In certain embodiments, the controller 130 may also control, manage, and/or coordinate the distribution of anonymized parameters (e.g., frame anonymization parameter sets) in MLO, as described in greater detail herein. Each AP MLD 120 may maintain a respective connection to the DS 140, which may be configured to manage communications among multiple AP MLDs. In certain embodiments, the DS 140 may include or otherwise be implemented by the controller 130.

The operations of the controller 130 may be implemented by any device or system, and may be combined or distributed across any number of systems. For example, the controller 130 may be a wireless local area network (WLAN) controller for the deployment of AP MLDs 120 within the system 100. In some examples, the controller 130 is included within or integrated with an AP MLD 120 and coordinates the links formed by that AP 120 (or otherwise provides control for that AP MLD). For example, each AP MLD 120 may include a controller that provides control for that AP MLD. In some embodiments, the controller 130 is separate from the AP MLDs 120 and provides control for those AP MLDs. In FIG. 1, for example, the controller 130 may communicate with the AP MLDs 120 1-3 via a (wired or wireless) backhaul, such as the DS 140. The AP MLDs 120 1-3 may also communicate with one another, e.g., directly or indirectly via a wireless or wireline backhaul, such as the DS 140. The database(s) 172 are representative of storage systems that may include, without limitation, radio resource configurations, radio resource management (RRM) information, frame anonymization parameters, among other information.

In certain embodiments, one or more the AP MLDs and/or the STA MLD 110 may support EDP operation to mitigate (and/or prevent) tracking of the STA MLD 110 within the wireless network. In some such embodiments, the AP MLD(s) 120 and the STA MLD 110 may be configured to perform one or more techniques described herein to improve distribution of anonymized parameters (e.g., associated with EDP operation) in MLO. As shown, each AP MLD 120 includes a respective anonymization tool 160 (e.g., AP MLD 120-1 includes an anonymization tool 160-1, AP MLD 120-2 includes an anonymization tool 160-2, and AP MLD 120-3 includes an anonymization tool 160-3), which is configured to perform one or more techniques described herein and is described in greater detail below. As also shown, the STA MLD 110 includes an anonymization tool 170, which is configured to perform one or more techniques described herein and is described in greater detail below. Each of the anonymization tools 160 and 170 may be implemented with hardware, software, or combinations thereof.

In certain embodiments, the AP MLD(s) 120 and/or STA MLD 120 may perform one or more techniques described herein that allow for reducing the amount of messaging used to establish anonymized parameters in MLO. For example, as described herein, as opposed to the AP MLD 120 and/or STA MLD 110 sending a respective communication frame indicating the respective frame anonymization parameter set to be used for communication on each link established between the AP MLD 120 and the STA MLD 110, the AP MLD 120 and/or the STA MLD 110 may use one or more techniques described herein to send a single communication frame including an indication of the respective frame anonymization parameter sets to be used for communication on multiple links established between the AP MLD 120 and the STA MLD 110. Upon receiving the single communication frame, the receiving AP MLD 120 or STA MLD 110 may use one or more techniques described herein to determine which frame anonymization parameter set is associated with each link, and use the corresponding frame anonymization parameter set(s) for a given link(s) when communicating on that link(s). In this manner, the techniques described herein can significantly reduce the amount of messaging involved in establishing anonymized parameters in MLO, thereby significantly improving the communication performance of clients during EDP operation in terms of increased throughput, decreased latency, and higher transmission range, as illustrative examples.

Note that certain embodiments described herein assume that each link that is established between a STA MLD 110 and an AP MLD 120 follows the same EDP epoch timing. As used herein, an EDP epoch (also referred to as an epoch) generally refers to a defined time interval (or window) in which a communication between a STA MLD and AP MLD is performed using a set of anonymized parameters, such as AID, MAC address, SN, PN, among other parameters, in order to prevent (or at least mitigate) unauthorized tracking of the STA MLD within the wireless network.

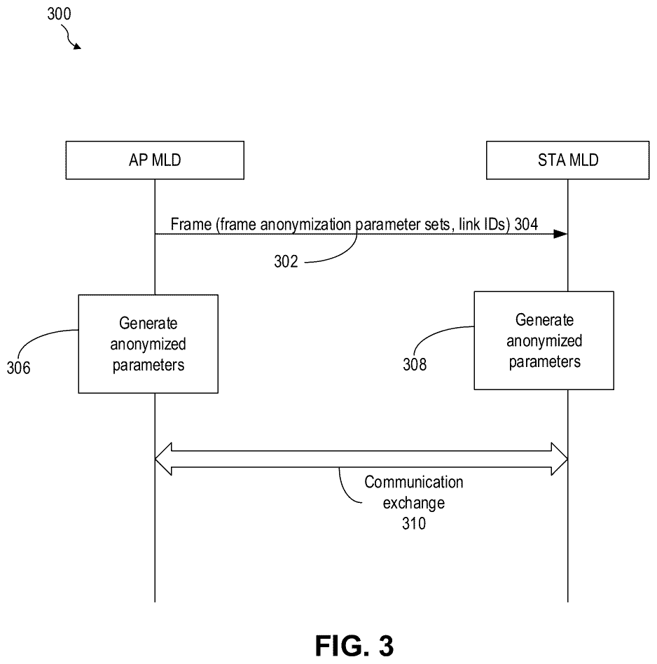

FIG. 3 illustrates an example call flow 300 for improving distribution of anonymized parameters in MLO, according to certain embodiments. Here, the call flow 300 depicts example operations by an AP MLD (e.g., AP MLD 120-1) and a STA MLD (e.g., STA MLD 110).

In certain embodiments, the AP MLD and the STA MLD may participate in a procedure for establishing frame anonymization parameters for multiple links in MLO, where the procedure involves communication of a single frame as opposed to multiple frames. By way of example, as illustrated at step 302, the AP MLD may transmit a single frame 304 on a first link (e.g. link ID 0) established between the AP MLD and STA MLD. The frame 304 may include (i) information associated with establishing frame anonymization parameter sets for multiple links (first link (link ID 0), second link (link ID 1), third link (link ID 2), and so on) established between the STA MLD and the AP MLD, (ii) an indication of the link IDs for the respective frame anonymization parameter sets, or (iii) a combination thereof. The information associated with establishing the frame anonymization parameter sets may include configuration parameters for establishing one or more anonymized parameters, such as AID, MAC address, PN, SN, etc. Such configuration parameters may include one or more derivation algorithms (e.g., a derivation algorithm for MAC address generation, a derivation algorithm for SN generation, a derivation algorithm for PN generation, etc.), MLD MAC address, among others, as illustrative examples.

In certain embodiments, the frame 304 in step 302 may be passed between the MLD MACs (e.g., U-MACs 220) of the AP MLD and the STA MLD. The frame 304 may define, for each parameter, what link the parameter belongs to. For example, in certain embodiments, the frame 304 may indicate (i) configuration parameters for configuring the SN anonymization, PN anonymization, AID anonymization, MAC address anonymization, MLD MAC anonymization, or any combination thereof, and (ii) the link ID for each of the SN/PN/AID/MAC/MLD MAC.

At step 306, the AP MLD generates anonymized parameters for the multiple links, e.g., based on the information that the AP MLD communicates within the frame 304. Similarly, at step 308, the STA MLD generates anonymized parameters for the multiple links, respectively, based in part on the information received within the frame 304.

For example, in certain embodiments, the frame 304 in step 302 may define a single set of configuration parameters for MAC address generation and indicate that the MAC addresses are to be multiplexed on the multiple links. For instance, if the STA MLD uses three links, then (i) the first three MAC addresses (e.g., first, second, and third MAC addresses) that are generated may be used on link 0, link 1, and link 2, respectively, in the first epoch, (ii) the second three MAC addresses (e.g., fourth, fifth, and sixth MAC addresses) that are generated may be used on link 3, link 4, and link 5, respectively, in the second epoch, (iii) and so on.

By way of another example, in certain embodiments, the frame 304 in step 302 may define a single set of configuration parameters for SN/PN offset generation and indicate that the SN/PN offsets are to be multiplexed on the multiple links. For instance, if the AP MLD and STA MLD use three links, then (i) the first three SN/PN offsets (e.g., first, second, and third SN/PN offsets) that are generated may be used on link 0, link 1, and link 2, respectively, in the first epoch, (ii) the second three SN/PN offsets (e.g., fourth, fifth, and sixth MAC addresses) that are generated may be used on link 3, link 4, and link 5, respectively, in the second epoch, (iii) and so on.

By way of another example, in certain embodiments, the frame 304 in step 302 may define a single set of configuration parameters for AID generation and indicate that the AIDs are to be multiplexed on the multiple links. For instance, if the STA MLD use three links, then (i) the first three AIDs (e.g., first, second, and third AIDs) that are generated may be used on link 0, link 1, and link 2, respectively, in the first epoch, (ii) the second three AIDs (e.g., fourth, fifth, and sixth AIDs) that are generated may be used on link 3, link 4, and link 5, respectively, in the second epoch, (iii) and so on.

In certain embodiments, the MLD MAC address of the AP MLD or the STA MLD may be anonymized. In some such embodiments, the frame 304 in step 302 may define a single set of configuration parameters for MLD MAC generation and indicate that the MLD MACs are to be multiplexed on the multiple links. For instance, if the STA MLD use three links, then (i) the first three MLD MACs (e.g., first, second, and third MLD MACs) that are generated may be used on link 0, link 1, and link 2, respectively, in the first epoch, (ii) the second three MLD MACs (e.g., fourth, fifth, and sixth MLD MACs) that are generated may be used on link 3, link 4, and link 5, respectively, in the second epoch, (iii) and so on.

In certain embodiments, the configuration parameters for at least one of MAC address generation, AID generation, MLD MAC generation, SN offset generation, or PN offset generation may include the MLD MAC address of the AP MLD or STA MLD. In some such embodiments, the AP MLD and/or STA MLD may generate the MAC addresses, AIDs, MLD MACs, SN offsets, and/or PN offsets for the multiple links based in part on the MLD MAC address of the AP MLD or STA MLD. For example, the derivation algorithm for MAC/AID/MLD MAC/SN/PN generation may be based on the MLD MAC. In embodiments where MAC/AID/MLD MAC/SN/PN generation is based in part on the MLD MAC, the multiplexing of the generated MAC/AID/MLD MAC/SN/PN onto the multiple links may still be performed using the techniques described herein. For example, each of the AP MLD and STA MLD may generate a sequence of parameters (one per EDP epoch) and take items for each link in a round-robin fashion, as described above.

At step 310, the AP MLD and STA MLD may perform communications using frames that include one or more anonymized parameters, such as the anonymized parameters in steps 306 and/or 308. For example, in some cases, the AP MLD may be a transmitting MLD and the STA MLD may be a receiving MLD. In other examples, the STA MLD may be the transmitting MLD and the AP MLD may be the receiving MLD.

In certain cases, when establishing frame anonymization parameter sets for EDP operation, the STA MLD may generate an anonymized parameter that collides with an anonymized parameter of another STA MLD. By way of example, the STA MLD may generate a MAC address to be used in a future epoch that collides with the MAC address of another STA MLD in that epoch. In such cases, when the AP MLD detects that an anonymized parameter expected to be used by a STA MLD in an upcoming epoch is calculated to collide with the anonymized parameter of another STA MLD, the AP MLD may transmit a collision warning indicating the expected anonymized parameter collision to the STA MLD. In response to the collision warning, the STA MLD may perform one or more actions to mitigate or prevent the collision. Such actions may include, for example, refraining from using the anonymized parameter for one or more epochs (including the epoch where the collision is expected to occur).

However, one potential issue with the current collision warning schemes is that the AP MLD generally has to send a collision warning to the STA MLD on each link that the AP MLD detects that a collision is expected to occur. In MLO, sending multiple collision warnings on multiple links can significantly impact the communication performance of the AP MLD and/or STA MLD in terms of reduced throughput, increased latency, and lower transmission range, as illustrative examples.

Accordingly, certain embodiments described herein provide techniques that allow for significantly reducing the amount of messaging involved in providing collisions warnings during frame anonymization in MLO. For example, in certain embodiments, when the STA MLD and AP MLD communicate about a particular anonymized parameter collision warning, the AP MLD may indicate the link ID(s) or the location(s) (e.g., N-th entries) within the generated sequence of anonymized parameters via an absolute number or the offset to the current epoch associated with the anonymized parameter collision warning.

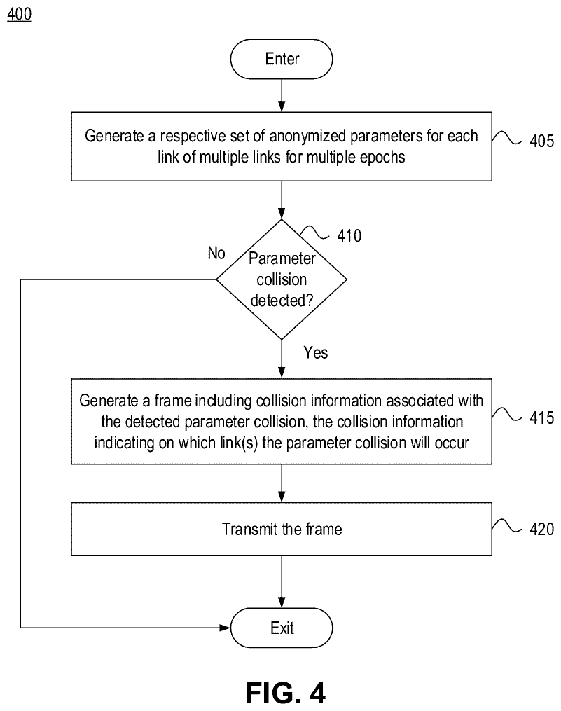

FIG. 4 is a flowchart of a method 400 for indicating anonymized parameter collisions in MLO wireless communication, according to certain embodiments. The method 400 may be performed by a computing device, such as an AP MLD 120. For example, the anonymization tool 160 may perform one or more of the blocks depicted in method 400.

Method 400 may enter at block 405, where the computing device generates a respective set of anonymized parameters for each link of multiple links for multiple epochs. The computing device may generate the respective sets of anonymized parameters using any technique or combination of techniques described above, e.g., with respect to FIG. 3. In certain embodiments, for example, the computing device may generate a sequence of parameters (one per EDP epoch) and take items for each link in a round-robin fashion, as described above.

At block 410, the computing device determines whether a collision for one of the anonymized parameters is expected to occur on one or more of the multiple links during one or more of the multiple epochs. If so, then the method 400 proceeds to block 415. If not, then the method 400 exits.

At block 415, the computing device generates a frame including collision information associated with the detected parameter collision. The collision information may indicate on which link(s) the parameter collision is expected to occur. In some cases, the collision information may further indicate at least one of the epoch at which the anonymized parameter collision on the link(s) is expected to occur. At block 420, the computing device transmits the frame. In certain embodiments, the frame may be transmitted on one of the links that the parameter collision is expected to occur. In other embodiments, the frame may be transmitted on one of the links that a parameter collision is not expected to occur.

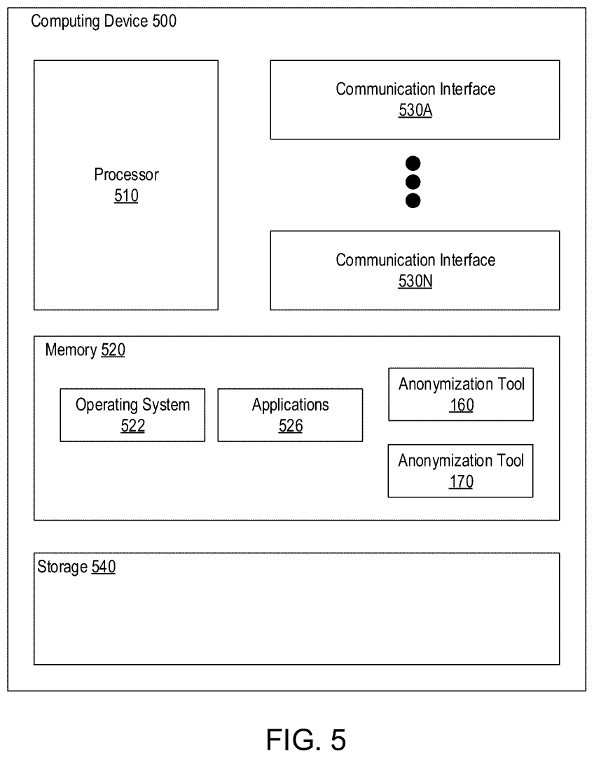

FIG. 5 illustrates an example computing device 500, according to one embodiment. The computing device 500 can be configured to perform one or more techniques described herein. For example, the computing device 500 can perform certain operations depicted in call flow 300, method 400 and any other techniques (or combination of techniques) described herein. The computing device 500 may be a network entity (e.g., an AP MLD, such as AP MLD 120) or a wireless device (e.g., STA MLD 110). The computing device 500 includes, without limitation, a processor 510, a memory 520, and one or more communication interfaces 530a-n (generally, communication interface 530). In one example, the communication interface 530 includes a radio.

The processor 510 may be any processing element capable of performing the functions described herein. The processor 510 represents a single processor, multiple processors, a processor with multiple cores, and combinations thereof. The communication interfaces 530 (e.g., radios) facilitate communications between the computing device 500 and other devices. The communications interfaces 530 are representative of wireless communications antennas and various wired communication ports.

The memory 520 may be either volatile or non-volatile memory and may include RAM, flash, cache, disk drives, and other computer readable memory storage devices. Although shown as a single entity, the memory 520 may be divided into different memory storage elements such as RAM and one or more hard disk drives. As shown, the memory 520 includes various instructions that are executable by the processor 510 to provide an operating system 522 to manage various functions of the computing device 500. The memory 520 also includes anonymization tool 160, anonymization tool 170, and one or more application(s) 526.

The computing device 500 may include storage (not shown). In some cases, the storage may be a disk drive or flash storage device. In some cases, the storage may be a combination of fixed and/or removable storage devices, such as fixed disc drives, solid state drives, removable memory cards, optical storage, network attached storage (NAS), or a storage area-network (SAN).

### EXAMPLE CLAUSES

Implementation examples are described in the following numbered clauses:

Clause 1: A computer-implemented method for wireless communication performed by an access point (AP) multi-link device (MLD), the computer-implemented method comprising: determining a respective set of anonymized parameters for each link of a plurality of links for a plurality of epochs, the plurality of links being established between the AP MLD and a station (STA) MLD; determining, based on the sets of anonymized parameters, that a plurality of anonymized parameter collisions are expected to occur on at least a first link and a second link of the plurality of links during one or more epochs of the plurality of epochs; generating a frame comprising an indication of the plurality of anonymized parameter collisions on the first link and the second link; and transmitting the frame to the STA MLD.

Clause 2: The computer-implemented method of Clause 1, wherein the frame comprises a first link identifier associated with the first link and a second link identifier associated with the second link.

Clause 3: The computer-implemented method in accordance with any of Clauses 1-2, wherein determining the respective sets of anonymized parameters comprises: generating a respective sequence of anonymized parameters for each epoch of the plurality of epochs; and allocating an anonymized parameter to each link for each epoch from the respective sequence of anonymized parameters for the epoch.

Clause 4: The computer-implemented method of Clause 3, wherein the frame comprises (i) an indication of a first location of a first anonymized parameter associated with the first link within a first sequence of anonymized parameters for a first epoch of the plurality of epochs and (ii) an indication of a second location of a second anonymized parameter associated with the second link within the first sequence of anonymized parameters for the first epoch.

Clause 5: The computer-implemented method of Clause 4, wherein the first location is based on a first offset to the first epoch and the second location is based on a second offset to the first epoch.

Clause 6: The computer-implemented method in accordance with any of Clauses 1-5, wherein the frame is transmitted on the first link or the second link.

Clause 7: The computer-implemented method in accordance with any of Clauses 1-5, wherein the frame is transmitted on a third link of the plurality of links.

Clause 8: The computer-implemented method in accordance with any of Clauses 1-7, wherein the plurality of anonymized parameter collisions comprises: a first collision between (i) a first anonymized parameter within the set of anonymized parameters for the first link during a first epoch of the plurality of epochs and (ii) a second anonymized parameter associated with another STA MLD during the first epoch; and a second collision between (i) a third anonymized parameter within the set of anonymized parameters for the second link during the first epoch and (ii) a fourth anonymized parameter associated with the other STA MLD during the first epoch.

Clause 9: The computer-implemented method in accordance with any of Clauses 1-7, wherein the plurality of anonymized parameter collisions comprises: a first collision between (i) a first anonymized parameter within the set of anonymized parameters for the first link during a first epoch of the plurality of epochs and (ii) a second anonymized parameter associated with another STA MLD during the first epoch; and a second collision between (i) a third anonymized parameter within the set of anonymized parameters for the second link during a second epoch of the plurality of epochs and (ii) a fourth anonymized parameter associated with the other STA MLD during the second epoch.

Clause 10: The computer-implemented method in accordance with any of Clauses 1-9, wherein the respective sets of anonymized parameters are determined based at least in part on a MLD medium access control (MAC) address associated with the AP MLD or the STA MLD.

Clause 11: A computing device comprising: one or more memories collectively storing instructions; and one or more processors communicatively coupled to the one or more memories, the one or more processors being individually or collectively configured to execute the instructions to cause the computing device to perform a method in accordance with any of Clauses 1-10.

Clause 12: A non-transitory computer-readable medium comprising computer-executable code, which when executed by one or more processors of a computing device perform a method in accordance with any of Clauses 1-10.

Clause 13: An apparatus comprising means for performing a method in accordance with any of Clauses 1-10.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A computer-implemented method for wireless communication performed by an access point (AP) multi-link device (MLD), the computer-implemented method comprising:
determining a respective set of anonymized parameters for each link of a plurality of links for a plurality of epochs, the plurality of links being established between the AP MLD and a station (STA) MLD;
determining, based on the sets of anonymized parameters, that a plurality of anonymized parameter collisions are expected to occur on at least a first link and a second link of the plurality of links during one or more epochs of the plurality of epochs;
generating a frame comprising an indication of the plurality of anonymized parameter collisions on the first link and the second link; and
transmitting the frame to the STA MLD.

2. The computer-implemented method of claim 1, wherein the frame comprises a first link identifier associated with the first link and a second link identifier associated with the second link.

3. The computer-implemented method of claim 1, wherein determining the respective sets of anonymized parameters comprises:
generating a respective sequence of anonymized parameters for each epoch of the plurality of epochs; and
allocating an anonymized parameter to each link for each epoch from the respective sequence of anonymized parameters for the epoch.

4. The computer-implemented method of claim 3, wherein the frame comprises (i) an indication of a first location of a first anonymized parameter associated with the first link within a first sequence of anonymized parameters for a first epoch of the plurality of epochs and (ii) an indication of a second location of a second anonymized parameter associated with the second link within the first sequence of anonymized parameters for the first epoch.

5. The computer-implemented method of claim 4, wherein the first location is based on a first offset to the first epoch and the second location is based on a second offset to the first epoch.

6. The computer-implemented method of claim 1, wherein the frame is transmitted on the first link or the second link.

7. The computer-implemented method of claim 1, wherein the frame is transmitted on a third link of the plurality of links.

8. The computer-implemented method of claim 1, wherein the plurality of anonymized parameter collisions comprises:
a first collision between (i) a first anonymized parameter within the set of anonymized parameters for the first link during a first epoch of the plurality of epochs and (ii) a second anonymized parameter associated with another STA MLD during the first epoch; and
a second collision between (i) a third anonymized parameter within the set of anonymized parameters for the second link during the first epoch and (ii) a fourth anonymized parameter associated with the other STA MLD during the first epoch.

9. The computer-implemented method of claim 1, wherein the plurality of anonymized parameter collisions comprises:
a first collision between (i) a first anonymized parameter within the set of anonymized parameters for the first link during a first epoch of the plurality of epochs and (ii) a second anonymized parameter associated with another STA MLD during the first epoch; and
a second collision between (i) a third anonymized parameter within the set of anonymized parameters for the second link during a second epoch of the plurality of epochs and (ii) a fourth anonymized parameter associated with the other STA MLD during the second epoch.

10. The computer-implemented method of claim 1, wherein the respective sets of anonymized parameters are determined based at least in part on a MLD medium access control (MAC) address associated with the AP MLD or the STA MLD.

11. An access point (AP) multi-link device (MLD) comprising:
one or more memories collectively storing instructions; and
one or more processors communicatively coupled to the one or more memories, the one or more processors being individually or collectively configured to execute the instructions to cause the AP MLD to perform an operation comprising:
determining a respective set of anonymized parameters for each link of a plurality of links for a plurality of epochs, the plurality of links being established between the AP MLD and a station (STA) MLD;
determining, based on the sets of anonymized parameters, that a plurality of anonymized parameter collisions are expected to occur on at least a first link and a second link of the plurality of links during one or more epochs of the plurality of epochs;
generating a frame comprising an indication of the plurality of anonymized parameter collisions on the first link and the second link; and
transmitting the frame to the STA MLD.

12. The AP MLD of claim 11, wherein the frame comprises a first link identifier associated with the first link and a second link identifier associated with the second link.

13. The AP MLD of claim 11, wherein determining the respective sets of anonymized parameters comprises:
generating a respective sequence of anonymized parameters for each epoch of the plurality of epoch; and
allocating an anonymized parameter to each link for each epoch from the respective sequence of anonymized parameters for the epoch.

14. The AP MLD of claim 13, wherein the frame comprises (i) an indication of a first location of a first anonymized parameter associated with the first link within a first sequence of anonymized parameters for a first epoch of the plurality of epochs and (ii) an indication of a second location of a second anonymized parameter associated with the second link within the first sequence of anonymized parameters for the first epoch.

15. The AP MLD of claim 14, wherein the first location is based on a first offset to the first epoch and the second location is based on a second offset to the first epoch.

16. The AP MLD of claim 11, wherein the frame is transmitted on the first link or the second link.

17. The AP MLD of claim 11, wherein the frame is transmitted on a third link of the plurality of links.

18. The AP MLD of claim 11, wherein the plurality of anonymized parameter collisions comprises:
a first collision between (i) a first anonymized parameter within the set of anonymized parameters for the first link during a first epoch of the plurality of epochs and (ii) a second anonymized parameter associated with another STA MLD during the first epoch; and
a second collision between (i) a third anonymized parameter within the set of anonymized parameters for the second link during the first epoch and (ii) a fourth anonymized parameter associated with the other STA MLD during the first epoch.

19. The AP MLD of claim 11, wherein the plurality of anonymized parameter collisions comprises:
a first collision between (i) a first anonymized parameter within the set of anonymized parameters for the first link during a first epoch of the plurality of epochs and (ii) a second anonymized parameter associated with another STA MLD during the first epoch; and
a second collision between (i) a third anonymized parameter within the set of anonymized parameters for the second link during a second epoch of the plurality of epochs and (ii) a fourth anonymized parameter associated with the other STA MLD during the second epoch.

20. A non-transitory computer-readable medium comprising computer-executable code, which when executed by one or more processors of an access point (AP) multi-link device (MLD) perform an operation comprising:
determining a respective set of anonymized parameters for each link of a plurality of links for a plurality of epochs, the plurality of links being established between the AP MLD and a station (STA) MLD;
determining, based on the sets of anonymized parameters, that a plurality of anonymized parameter collisions are expected to occur on at least a first link and a second link of the plurality of links during one or more epochs of the plurality of epochs;
generating a frame comprising an indication of the plurality of anonymized parameter collisions on the first link and the second link; and
transmitting the frame to the STA MLD.
